(19) United States
(12) Patent Application Publication
(10) Pub. No.: US 2008/0312951 A1
(43) Pub. Date: Dec. 18, 2008

(54) Method for Optimizing Design Delivery and Implementation of Innovative Products in Healthcare

(76) Inventors: Berd Herpichboehm, Mannheim (DE); Peter Kaspar, Weilheim (DE); Uwe Oberlaender, Penzberg (DE)

Correspondence Address: Roche Molecular Systems, Inc.;Patent Law Department, 4300 Hacienda Drive, Pleasanton, CA, 94588, US

(21) Appl. No.: 11/658,570

(22) PCT Filed: Aug. 24, 2005
(86) PCT No.: PCT/EP2005/009128

§ 371 Date: Jan. 24, 2007

(30) Foreign Application Priority Data
Aug. 25, 2004 (EP) 04020112.1

(51) Int. Cl. G06Q 50/00

(52) U.S. Cl. 705/2

(57) ABSTRACT

Thus, the invention provides a new method for generating a multi purpose cost/benefit analysis based on the generation of a multi dimensional database. Starting from this database, different models for various medical scenarios can be created.

More precisely, the present invention is related to a method and a database for optimizing design, delivery and implementation of innovative products in healthcare. More precisely, a current treatment scenario of a patient is being loaded from a memory, a default case or a stored scenario from previous customer interviews or publication. The current treatment scenario is modified by input relating to new options such as application of a new health care product. Effects on the current healthcare provider's cost, resource utilization and medical outcome record are determined. Viewpoints of single or various stakeholders involved can be activated. Multiple scenarios can easily be created, so stakeholders can investigate sensitivity of their scenario to key uncertainties.

### BACKGROUND OF THE INVENTION

1. Field of the Invention

The present invention is directed to a new method for the selection of optimal parameters for appropriate medical treatment or diagnosis of a disease.

2. Description of the Related Art

New medical products can have a significant impact in clinical outcome and total health care cost. Often usage of such products requires process changes in patient care which may alter resource utilization across several providers or medical specialties. It may involve upfront investments in both machinery and training. Also established reimbursement procedures may be an obstacle to adopt overall beneficial innovations.

Implementation of new products therefore faces many obstacles and risks, which is further aggravated by the pressure on healthcare providers for cost containment which, in recent years, has been increasing on a global scale.

The pharmaceutical, the diagnostics and medical devices industry at the same time face increasing cost in developing new products, not least by increasing regulations including demands to prove utility and cost benefit in multi-national clinical trials.

In order to best target scarce resources, and to bring meaningful innovations to the patients as quickly as possible, it is of paramount importance to streamline the process of product design, clinical trials, and widespread implementation/adoption.

Currently, the state of the art provides several independent tools in order to evaluate options for decisions on appropriate pharmaceutical treatments or diagnostic analyses:

### (a) Value Analysis; Quality Function Deployment (QFD) and House of Quality

Since many years there are several highly formalized tools in use that are tailored to trade off technical options in product design vs. perceived customer utility, the latter being often derived from market research, notably focus groups.

Examples: Value analysis according to German Guideline for Value Analysis DIN 69910 obtainable e.g. via www.vdi.de; QFD/HOQ references: Chapter on QFD in “Trends in Design and Manufacturing” in: http://www.mfg.mtu.edu/cyberman/quality/dfm/trends.html; Eldin, N., Cost Engineering 44 (2002) 28-37; Howell, D., Professional Engineering 13 (2000) 39.

Limitations: Looks on options in the development process only; builds mostly on spontaneous perceptions about likes and dislikes voiced by customers w/o modelling the implications of product use in their healthcare facility.

### (b) Advance Outcome Studies

An improvement over approach (a) has been suggested by Enterprise Analysis Corp. (EAC). How a new product changes existing care paths is modelled, depending on specifications of the product. This is a specific application of approach (a), including some elements of (d), geared as consulting service to manufacturers for early stage product development.

Example: http://www.eacorp.com sections: consulting, and reports/crossindustry (details not revealed on website but communicated to Roche by Emery Stephans, EAC, in private communication).

Limitations: Designed to consult manufacturers in critical product definition issues. Costly.

### (c) Software Solutions to Guide Purchase Decisions

Across many industries and customers solutions are developed, and can be tailored, that aid the process of selecting best-suitable products, either as a service to the purchaser, or as a selling tool to the manufacturer.

Example: www.activedecisions.com/solutions

Limitations: Designed to “rationalize” product choice vs predefined criteria and available options. Often not more than a marketing-gadget providing more or less entertaining “interactivity” on internet sites of consumer-good companies.

Likewise, solutions are available, and can be tailored to new applications, to make a business case for a new product related decision, e.g. www.solutionmatrix.com/business-case-services

Limitations: A formalized framework or toolbox for making financial assessments about product or project choices.

### (d) Decision Tree Based Health-Economic Software

Current and newly proposed paths of patient care are modelled in terms of cost and outcome. Impact of any variable on cost and outcome can be determined. Uncertainties can also be dealt with by applying MonteCarlo simulations (see e.g. http://www.woodmac.com/pdf/wmsolution1.pdf.), i.e. a number of patients can be loaded into the model and random outcomes can be created and statistically evaluated for sensitivity analysis, or in order to determine which number is required, e.g. in trials, for the needed statistical significance of desired results.

The tool is widely used for scientific publications, and to prove overall health benefits of new products e.g. to lobby for reimbursement. It is also suggested to be used in an initial step from which the suggested invention branches off.

Example: DataPro from TreeAgeInc (www.treeage.com, used e.g. in: Angus, D. E., et al., Crit. Care Med. 31 (2003) 1-11); or e.g. used to back up reimbursement negotiations for Roche's pro-BNP test.

Limitations: The procedure compares alternative treatments from one standpoint, usually the total healthcare cost and can not look from different angles of view, e.g. caregiver, his internal “silos”, and implication of changing reimbursement rules. etc. Thus, this sophisticated tool is predominantly useful for the health-economists to make a case for treatment changes and reimbursement, but usually will not have any advantage for hospital administrators, ICU heads/clinical case managers, and sales people.

### (e) Applications of Tree-Based Health-Economics Implemented in Healthcare

Several applications exist that translate tree-based health-economics into tools meant to drive patient behaviour towards improved outcomes.

Examples: Improved diabetes control: www.mellibase.de; Cholesterol monitoring to reduce risk from heart disease: www.lifestreamtech.com.

Limitations: A motivational tool, projecting long term benefits for patient and total savings for the payer, with study data backing up the integrated probabilities when related to single patients.

### (f) Software-Supported Practice Guidelines

Managed care organizations and some hospital chains have implemented computer-assisted care paths.

Limitations: This is usually proprietary software dedicated to the interest of hospital management with the intention to streamline care, record resource utilization and bill patients or payers.

### (g) Consulting Software for Laboratories

Several companies sell software aimed at improving laboratory services, e.g. turn-around times, reporting, added value through data-mining, or cost per reported result.

Examples: Simlab from www.trillium.de; middleware from Roche USA and Data Innovations: http://us.labsystems.roche.com/products/middleware.pdf: “Middleware is an IT system that can significantly optimize results production as it sits strategically between your instruments and LIS. It improves your turn-around-time and provides the highest quality of health information, while reducing your labor requirements. Furthermore, it provides your laboratory with a higher degree of marketability to your clients. And it is simple to use.” http://www.datainnovations.com/news/newslink/NewsLink_July_{—}2003.pdf.

Limitations: Very narrow focus on the laboratory; although broad on analytical parameters=focussing on other aspects than improved patient care in a limited indication range.

### (h) Consulting Software for Clinicians, Doctors

Several companies sell or offer for free software aimed at improving coding of patient cases for reimbursement (ICD-10 codes and e.g. how they best group for maximizing reimbursement under DRGs).

Examples: “DRG watchdog 2.5”, download offered by: www.trillium.de

Limitations: Very narrow focus on reimbursement maximization; broad on disease stage focussing on other aspects than improved patient care in a limited indication range.

### (i) Consulting Project

Manufacturers of healthcare-related goods, caregivers, and payers frequently devise projects-supported by specialized consultants that shall guide them to good decisions. If none of the solutions mentioned above is easily adaptable, a lengthy and costly project must be designed and executed—usually with the goal to support one critical decision of those who commissioned the research.

Limitation: It is time-consuming, costly and usually only used by one party in one critical decision. Yet it is not attempted to model the health-economic situation across the spectrum of involved players, and to enhance their communication.

Potential advantage: Simultaneously several change processes can be investigated.

Health-political changes have become a constant, emerging new pathogens and resistances seem to alarm us in ever shorter periods, promising innovations get caught in regulatory or reimbursement hurdles. Clear predictions about the future seem increasingly hard to make.

Therefore it was an object of the present invention to come up with an interactive, easy-to-use and broadly applicable tool that does not really attempt to answer all questions but that mainly is providing a good-enough framework for management of decisions under uncertainty and as such will help the innovators who a willing to take a calculated risk to shape the future.

### SUMMARY OF THE INVENTION

Thus, the invention provides a new method for generating a multi purpose cost/benefit analysis based on the generation of a multi dimensional database. Starting from this database, different models for various medical scenarios can be created.

The present invention is related to a database comprising:
a) current treatment scenarios of patients;
b) parameters that describe a suggested treatment change;
c) parameters that are needed to describe how treatment changes may affect involved parties differently.

The present invention is also related to a computer-readable medium comprising a respective database.

In a specific embodiment, said computer-readable medium further comprises a program to perform algorithms that build customized new scenarios and present them in an output file.

More precisely, in a first aspect, the present invention is directed to a computer-readable medium comprising a database, said database comprising:
a) current modes of treatment for a defined set of patients;
b) analytical parameters associated with a suggested treatment change;
c) parameters associated with treatment quality, treatment costs and reimbursement income of different providers of healthcare products and services.

Preferably, said medium further comprises a program to perform algorithms that calculate customized sets of new parameters associated with a treatment change in an output file.

In a second aspect, the present invention is directed to a method for calculating individually chosen sets of parameters associated with a treatment change, comprising
a) inputting data for description of current medical care which are relevant to a change of treatment;
b) inputting data as required for description of said change of treatment;
c) storing inputs in a database;
d) calculating a set of different parameters for administering at least two different modes of treatment;
e) presenting at least one parameter associated with treatment quality, one parameter associated with treatment costs and one parameter associated with reimbursement income.

Preferably, such a method further comprises at least one step of storing outputs in said database.

In addition, the present invention is also directed to a computer program product capable of performing a method as disclosed above by means of processing a database, characterized in that said database comprises
a) current modes of treatment of patients;
b) parameters that describe a suggested treatment change;
c) parameters in dictating how treatment changes affect different providers of healthcare products and services differently.

In the context of the present invention the term “change of treatment” is defined as a change triggered by the introduction of a product innovation or a service innovation, such as but not limited to a different diagnostic method, or administering of a different drug.

Also in the context of the present invention, the term “set of different parameters” is defined as a set of values based on a statistical analysis of disease progression, available laboratory values and cost data associated with medical care”.

Also in the context of the present invention, the term “healthcare and healthcare service provider” is understood to be
a medical department of a hospital;
a hospital laboratory such as laboratory for performing in vitro diagnostics;
a hospital department for diagnostic imaging;
a primary care physician;
a provider of a pharmaceutical drug;
a provider of a diagnostic test, or
health insurance company.

Further in the context of the present invention the term “customized sets of parameters” is understood as multiple sets of parameters characterized in that said sets of parameters can differ for different health care providers.

The present invention is also directed to a business model wherein the results of the inventive method are presented in output files to at least one provider of healthcare products or services to support decisions related to design or implementation of new products or processes.

### DESCRIPTION OF THE FIGURES

The method and the model according to the present invention are further described by the accompanying drawings in which:

FIG. 1 First part of a flow chart showing the selections according to the present method.

FIG. 2 Second flow part of the method according to the present invention showing inputs required for a current case and the inputs required for new options and the monitoring of results.

FIG. 3 Third part of the flow chart of the present invention including a sensitivity explanation and management of scenarios.

### DETAILED DESCRIPTION OF THE INVENTION

The present invention is related to a method and a database for optimizing design, delivery and implementation of innovative products in healthcare. More precisely, a current treatment scenario of a patient is being loaded from a memory, a default case or a stored scenario from previous customer interviews or publication. The current treatment scenario is modified by input relating to new options such as application of a new health care product. Effects on the current healthcare provider's cost, resource utilization and medical outcome record are determined. Viewpoints of single or various stakeholders involved can be activated. Multiple scenarios can easily be created, so stakeholders can investigate sensitivity of their scenario to key uncertainties.

This invention provides a new method by means of combining and expanding elements from several established tools which have been in use to aid in parts of this overall process into a total solution that
can be applied in the total value chain,
will bring the parties together in a dynamic communication framework,
e.g. educates product developers about how the product's features impact daily utilization in real customer scenarios;
e.g. projects the targeted use for clinicians and laboratory, including aspects like trade-off of cost to provide rapid laboratory response vs. clinical benefits)
provides a consistent framework, including sensitivity analysis, for strategic decisions at several points of the value chain
provides a tool that helps monitor implementation
is a learning tool that increases its value over time.

The basic approach according to the method of the present invention for optimizing design, delivery and implementation of innovative products in healthcare is to
describe the current practice of medicine in the applicable field and then describe the impact that the new product will have (those aspects are best laid out in form of a decision tree);
pay attention to such details, as who is incurring costs and who will have the benefits, particularly in the context of a given (or over time changing) reimbursement and/or provider (e.g. hospital)-internal accounting system;
bring up the issue of how freed up capacities can be either deleted or otherwise utilized, so calculated savings are truly realized;
present the benefits referring to key issues of the profession, such as outsourcing pressure on laboratories, case-cost pressure on hospital clinicians;
provide to the hospital management a projection on important benchmarks such as the average length of patient hospital stay, mortality of patients or total annual cost and case load, data which might influence occupancy and therefore overall success in the future;
develop a computer program product which allows flexibility with regard to viewpoints, scenarios, easy addition of relevant parameters, sensitivity exploration, adaptation to different products, reimbursement scenarios, individual disease or pathogen prevalences etc.

Thus, the present invention is directed to the generation of a database including relevant clinical, scientific, monetary, and product related information as disclosed above.

Specifically, if the new healthcare product is a novel diagnostic test or a new pharmaceutical drug, the solution according to the instant invention provides additional details:

In a first aspect, clinicians are provided with quantitative data on clinical improvements and data on costs depending on their test or drug utilization. In addition, study data are provided as back up.

In a second aspect, the laboratory is supported to optimize and communicate the cost/utility of its offerings to clinicians, taking the guaranteed response time also into account This may relate to options such as staff number, opening times or implications of eventual outsourcing.

The method according to the present invention helps diagnostic product-manufacturers in terms of optimizing product design and positioning from am end user-standpoint, based on multiple real scenarios of envisioned usage such as detailed aspects like hands-on time required by the end user. In addition, the new method assists in designing clinical outcome studies by means of accelerated selection of suitable sites and evaluation of results due to the capability of the model to focus attention to the most sensitive/critical parameters.

The solution according to the present invention allows to guide and monitor implementation of a new method into patient treatment and to analyze different implementation options on the healthcare provider level. For example, staff number and outsourcing options or pharmacy dispensing system or IT-supported medical information transfer and decision making may become allocated appropriately.

The method according to the present invention is very easy to use, since it provides one or more default scenarios supported by literature and trial data in the respective applicable field. It also allows for a high degree of customization to reflect as many relevant cases as possible. Furthermore, the model generated by the method according to the present invention is suitable for sensitivity analysis in areas of persisting uncertainty.

When used within a healthcare institution, e.g. a hospital, the proposed new model not only provides for a consistent set of scenarios, which are established on different viewpoints for one application such as a hospital utilizing a new diagnostic product. It even extends beyond that in that all scenarios created from a number of hospitals in a country can very easily be compared or turned into an average or total scenario. This facilitates learning in general, and customer segmentation in particular which will increase sales efficiency and customer satisfaction.

Furthermore, it is advantageous, if the software used in the present model is safe from unauthorized changes, but yet easily updatable, e.g. with new data coming from clinical trials or the incorporation of aspects from country-specific regulations and reimbursement systems.

In a first aspect, the present invention is directed to a database comprising:
a) a table comprising current treatment scenarios of patients;
b) a table comprising parameters that describe a suggested treatment change;
c) a table comprising parameters that are needed to describe how treatment changes may affect involved parties differently.

Such a database usually also comprises a further table comprising formulas or relations between the input and output variables. The formulas or relations may be based on respective algorithms representing a decision tree.

The table comprising current treatment scenarios of patients may comprise one or several default (“average” or literature-supported) case(s), and/or scenarios developed with healthcare professionals for their hospitals. The scenarios developed with healthcare professionals may comprise either a databank for individual sets of inputs like number of patients in the target indication, daily costs such as patient costs, current complication rates, hourly costs of involved staff, or alternatively complete scenarios.

The table comprising parameters that describe the suggested treatment change may comprise a new patient flow, e.g. in decision-tree format, or relevant parameters of new products and processes to be used, such as sensitivity of a new test, side effect incidence of a new drug, changes in workload for hospital staff, or cost data for old and new products.

The table comprising parameters that are needed to describe how treatment changes may affect involved parties differently may comprise valuation of workload changes in different hospital departments, and/or how the reimbursement system divides cost and benefits up between payer and provider.

In addition, the database may comprise one or more tables comprising literature quotes, product evaluation and clinical trial data on which the default case(s) are based.

In a second aspect, the present invention is directed to a computer-readable medium or a computer-readable storage medium comprising any database database as disclosed above. As it is known in the art, a computer readable medium may be for example without limiting the scope of the present invention a working memory that can process building new scenarios and representing them in desired output formats, a medium for inputs (keyboard, and/or for reading-in electronic input files), or a hard disc or memory stick or reading device for storage discs.

Such a computer-readable medium according to the present invention may further comprise
a program to perform algorithms that build customized new scenarios and present them in an output file, and/or
a program to perform algorithms that build customized new scenarios and present them, and/or
a program to perform algorithms that de-couple presentation of results from the interactive complete program such that communication of results is enhanced while the ownership of the method and confidential data from other clients can be contained, and/or
a program to perform algorithms for password-locked unprotect-routines which allow authorized users access to the database for structural modifications, e.g. to include customized aspects, or to create entirely new methods for other healthcare products, and/or
a program to perform algorithms for copy-protection.

In a third aspect, the present invention is directed to a method for optimizing design, delivery and implementation of healthcare products or processes comprising:
a) data input for customized description of current medical care as relevant to the envisioned opportunity for change;
b) data input as required for customized description of the envisioned changes;
c) storing inputs in a database;
d) calculating scenarios; and
e) presenting results.

In a specific embodiment, at least steps c) and d) are calculated for different viewpoints.

The data input as required for customized description of the envisioned changes may include data on utilizing a new product or processes in a hospital or how single changed features of such a product or options regarding new processes change the cost/benefit relation for customers.

The calculation of scenarios may be achieved or produced by overwriting a selected default case. Alternatively, such a calculation may be a sensitivity analysis of one or more pre-existing scenarios to changed in certain inputs.

Results may for example be presented as tables, charts (bar graphs, pie charts etc), in a decision tree format (new vs old patient flow, scaled to the provider), in form of a break-even and return-on-investment analysis, or in form of tornado-diagrams for sensitivity analysis.

In a specific embodiment, inputs and results may be stored in a large database (e.g. as columns in a MSExcel table) in such a way that they can be used for special applications utilizing more than one stored scenario at-a-time. Examples for such different applications are characterization of one hospital provider against the background of others (sanity checking; customer segmentation), analysis of how changes in product specifications or price influence the scenarios, or derivation of proposals for reimbursement changes

In another specific embodiment, the inventive that can be dispersed to several or many users, and allows for each single user as well as for groups or all of them to upload/download data from/to others easily. The amount of data included in the database (field experience, customer reflections on utility etc) will increase the value of the method in each field of application (e.g. new product X). This makes the method a learning tool (as opposed to e.g. state-of-art tool which is every-time the same tool, freshly applied to a new case by a specialist), enabling efficient execution of innovation in healthcare along the entire value creation from product design to implementation.

In a further embodiment which is not at all mutually exclusive to the one disclosed above, the method allows to adopt different viewpoints regarding the detail of inputs and customized outputs as well as producing scenarios that are consistent between different viewpoints. Assessments can be done concurrently, or at different times separately. This can facilitate communication between parties that have to work together to make an innovation in medicine successful Obstacles that single needed contributors may face can be identified and solutions can be found that create a win-win situation for each party involved.

In a fourth aspect, the present invention is directed to a computer program product capable of performing a method as disclosed above by means of processing a database according to the invention

In a fifth aspect, the present invention is directed to a business model comprising
a) performing a method according to the invention, and
b) presenting the output files to at least one provider of healthcare products or services to support decisions related to the design or implementation of new products or processes.

Decisions which may be supported may for example be but are product design, pricing, customer segmentation, reimbursement, definition of how widely or restrictive the new product shall be used in a healthcare setting, changes in lab services, impact if outsourced, hospital-internal budgeting implications, and valuation of freed capacities.

This is efficiently achieved with an easy to learn system that uses good-enough models for decision making under uncertainty, and utilizes all data, notably also trial data and customer feedbacks from dispersed, parallel users of the method. Furthermore, the potential for win-win situations along the complete timeline and valueline can be explored. As a consequence, decisions on health care innovations can be directed such that efficient execution and rapidly materializing patient benefits are established

### Modules and How a Model is Built/Adapted to a New Field

Further below, the essential functions, the setting up of the method according to the present invention are further described.

In an initial step a hypothesis is formulated—based on a decision tree—how the new product or the new method is expected to change patient treatment. Parameters for clinical outcome and generated costs are defined and a respective database is created. The difference before and after general application of a specific product such as a pharmaceutical compound or a diagnostic test can be evaluated, assuming a constant number of patients suffering from the same disease, in order to see whether a change in principal makes sense. For arriving at good initial decisions, it might be sufficient to capture only those aspects where the current and new methods are different, i.e. to quantify these differentials and determine how these differentials influence the results in terms of costs and patients' length of stay and mortality.

In a second step, credibility to the hypothesis is established. This is performed by searching literature of the applicable field or capture surrogate data that can be easily plugged into the model and extend the generated database. The plugging in of surrogate data or search literature is relevant, if a gap can be bridged reasonably by this data. Often, data can be found such as past data or newly captured data from situations where healthcare providers have been confronted with a similar situation. Conversely, and if data are totally lacking, the manufacturer could also use the model to define the minimum needed performance criteria of a new drug or device so that customers would have an overall benefit of using it.

After the new product has been made available, trial results can be plugged easily into the generated database in order to overwrite outdated assumptions. This can also be performed for all scenarios investigated in the past. Moreover, it provides a database as to whom to contact and inform, in case the overall outcome changes favourably or unfavourably by such new information. Likewise the manufacturer can rethink positioning, target group and pricing upon such new data.

In a third step, a basic scenario, the study object, or the boundaries of the system to be investigated can be defined. The basic scenario further is fed by patient demographics of the entity such as an entire hospital or subgroups within the hospital. Further, the cost and outcome data, such as patients stay-time in hospital or costs generated in a past period of the model can be plugged into the basic scenario being established.

In a fourth step, the relevant parameters of the new product or the new methods can be defined and added to the existing database. Generated costs and relevant performance parameters are important variables for the method according to the present invention. This may require inclusion of a proved target application such as segmentation of the patient population using additional criteria.

In a fifth step, an implementation of the upfront and fixed costs is performed. This may include the purchase of instrumentation, the utilizing of relevant infrastructure such as storage or IT-capacities and further the training requirements. Thus, additional monetary parameters are included into the database.

In a further, sixth step, multi-period effects can be defined. This goes beyond the simple before/after comparison of step 1, because it includes an option to model multiple years of “business as usual” vs. the new situation, since only this can finally be monitored in the implementation.

There are benefits that increase over time, for instance those benchmarks for the relevant healthcare provider which may improve over time and consequently attract more clients. Examples for such benchmarks are average length of stay in intensive care, postoperative infection rates, reduced the rate of antibiotic resistance. However, benefits can also decrease in later periods which might be the case if improvements are not reached to 100%, e.g. if the system reduces reimbursements after a while to establish then a new state of the art.

In a seventh step, it is feasible to focus attention on identifying all parties or stakeholders that are relevant to the model. It is to be determined which party bears what costs and which party has which benefit as compared to the status quo. This is an essential concern in many healthcare systems because of their budgetary “silos” and non-market driven reimbursement rules. Not only the insurance companies, but also rules established between different hospital departments may be an obstacle to implementation. Moreover, rational suggestions can be derived from the model according to the present invention how to overcome the obstacles.

In an 8th step, alternative use of resources and segmentation is suggested: In this step, criteria can be identified whether or not the costs associated with the intended medical progress exceed the willingness to bear those. In this case, it has to be decided whether or not there are better ways to spend the resources. When the above-reference no-go criteria might be met, systemic or multi-period effects can be considered to prove whether the no-go criteria shall still be sustained given the respective hospital's image and the strategy thereof. This constitutes a relatively high value for all parties involved to arrive quite quickly at the decision not to embark on the new procedure if the costs involved are excessive. This saves money and resources. The manufacturer can summarize such experiences in segmenting customers and defining alternative products or services to make the offering more viable for a bigger customer base in the future.

In a 9^{th} step, reimbursement negotiations are considered to be initiated on a district or national level, for checking whether it may be worth to embark on negotiations on a district or national level with insurance companies or other potential parties to remover barriers. In addition, the method according to the invention will also enable to formulate quantitative suggestions for future reimbursement amendments.

In a 10^{th} step generation of an implementation plan is suggested, which is another important aspect of the method according to the invention. This plan forms a solid basis to facilitate communication with and within the healthcare facilities when finally, alternative ways of implementation need to be assessed and weighed against each other. It can be decided how selectively it is made available to patients or which test cost medical doctors are willing to pay dependent on the service quality offered by the laboratories.

Step 11 is implementation monitoring: the decision for an implementation is not a guarantee for success. The expectations that were part of the decision to implement the new method or the new product such as a new diagnostic product must be transformed into actual targets that are monitored. This will enhance the motivation and the learning experience. A special aspect for monitoring is the monitoring of key-uncertainties. In order to achieve this, a sensitivity analysis can be included describing the key-uncertainties.

In an alternative embodiment, one, several or all steps 1 two 11 may be subjected to analyses starting from different viewpoints. Various viewpoints from which the analysis might be important can be defined allowing for customized inputs and outputs, respectively. The various viewpoints may capture essential assumptions and results from the viewpoint of a doctor, a laboratorian or a hospital manager or still further, a product developer or an insurance manager. Thus, the model according to the present invention can be adopted according to the person who might want to look at the situation from one or several different viewpoints. By means of providing a multi viewpoint analysis, communication between several parties involved is based on a single and comprehensive information source and thus communication on a more structure and rational basis.

The database generated according to the invention provides for a high degree of functionality in terms of extracting all scenarios in spreadsheet-presentation for any further analysis.

### Applications of the Method and Database According to the Invention

The analysis according to the present invention starts with an introductory part presenting the products and methods which can be analyzed in certain clinical settings. The angle of view can be selected, such as the view with a doctor's eye, the view of a laboratorian, the view of a hospital manager, a manufacturer or an insurance manager or the like.

For highly complex situations, where customers cannot really start from the same default scenario to model their situation and/or intended change, a “light version” of the model can be switched before that initial screen, in which, depending on answers to a set of usually 5 to max 10 questions, customers can be segmented. This will trigger the most suitable start-scenario being selected as starting point for modelling their situation, while eliminating a host of input data is not really needed for their specific case.

After selecting the viewpoints from which the analysis shall be made, the product(s) under consideration, and a suitable start-scenario, the “basic inputs” sheet will require to accept or overwrite crucial data such as patient demographics, which portion of the potential target group shall be considered for modified treatment, capacity utilization e.g. bed occupancy, or current outcomes and associated costs.

Data on outcome differences expected from the new method will be referenced e.g. by information points leading to pop-up windows that refer to clinical trial data to the extent already available. In addition, also surrogate data that form reasonable hypotheses about expected changes may be shown.

For example, a new diagnostic product might increase the number of patients getting the best possible treatment at the earliest possible time. However, already prior to the advent of the new diagnostic product, usually a certain smaller number of patients already got treated that way, so there might be data comparing cohorts with earlier versus later interventions, and what might be gained by intervening earlier.

Furthermore, product and method characteristics are given, taking into account related healthcare provider characteristics such as laboratory capacity, or the current drug formulary of the pharmacy.

A broad overview concerning the expected impact of the new product or the new method in treatment in terms of cost and outcome is presented which can be subdivided into

a) the impact before versus after a new scenario;
b) upfront implementation costs; and
c) multi-period effects.

It is determined whether there is a willingness to pay for the suggested improvement which might not be relevant if there is an improvement raising the total costs. On the other hand, the model will calculate the willingness to pay, required in order to adopt the new product or the new method. In terms of results, the model and database according to the present invention gives the medical benefit in terms of treatment effectiveness. It also provides the cost benefit such as costs per case, i.e. costs per patient and an outcome benchmark when using the new product such as a diagnostic product or a new diagnostic method.

It allows a comparison of the treatment before using the new product or the new method before or after the use of the new product or the new method in terms of laboratory cost, utilization, opening times and changes to clinicians. Optionally, the results can be presented before and after treatment with the new product in a decision tree format.

Further, the amortization of upfront investments such as training, IT and logistics integration in terms of an expected break-even period or an internal rate of return can be provided.

By refined multi-period scenarios which take into account secondary effects such as increased hospital attractiveness by a higher occupancy as compared to the reference scenario, the success of implementation of a new product or a new method can be monitored can be predicted.

An optional feature is the exploration of how provider-internal accounting method changes or national reimbursement changes would affect the distribution of the cost benefits across the parties involved. Further considerations concerning outsourcing activities in terms of make or buy can be explored as well. Further outputs obtainable by the database according to the present invention are the sensitivity of customers' cost benefit to variation of product specification which is important for designing the product, or respectively, its follow-up product. Further, the design and the time consumption of trials can be influenced by the results obtained as outputs of the model according to the present invention.

### EXAMPLE

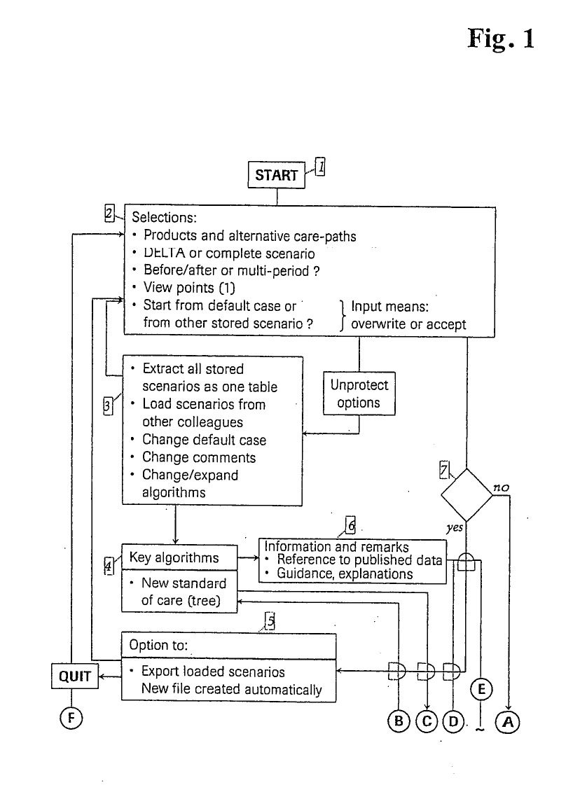

The flow chart represented by FIGS. 1, 2 and 3, respectively, shows the principles of the method and database structure according to the present invention. Once the method is being started, various selections are presented to the user. Selections can be made between products and respective alternative care-path's.

Further, it can be selected whether a complete scenario is to be created or whether only a partial analysis shall be performed. In other words, the user is asked in the part “selections” whether a complete scenario should be performed or whether only the situation before the treatment change shall be compared to the situation after treatment with the new product. In the part “selections”, also the different viewpoints can be selected such as the viewpoint of a clinician, a laboratory manager, a hospital manager or a insurance-related person.

Further, the part “selections” offers the pre-setting of the start of the model based on a default case or based on a further performed, stored scenario. Concerning the part “selections” the user is offered the possibility to load an already performed scenario similar to his own situation, viewed and further customized (overwritten, where the situation can differ).

Still further, in the part “selections”, all stored scenarios can be extracted as one table. Alternatively, scenarios previously prepared by other colleagues can be loaded to allow for a comparison thereof. If it is selected to start the respective model form a default case, the default case parameters or preconditions can be changed as well. Further, eventually provided comments on certain details of an already stored scenario can be deleted or changed as required. Further, the part “selections” of the flow chart given in FIG. 1 allows for a change or expansion of algorithms.

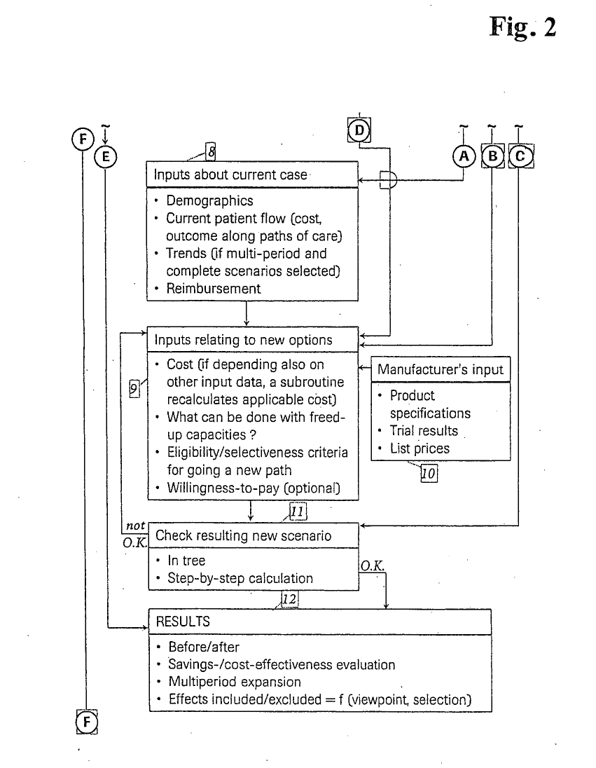

According to the selection being made, the key algorithms are started according to what is the standard of care that is reflected in the decision tree of the database. Inputs are prompted to overwrite the default data with institution specific inputs. This process is guided with “information”- and “remarks”-block of the flow chart given in the middle of FIG. 2. It can be further facilitated by giving those input fields a different colour that differ strongly between providers (e.g. the numbers of intensive care beds) and that strongly affect the result. It can also be facilitated further by giving fields a different colour which are well supported by data or to which the result is fairly insensitive.

Assigned to the selection-block 2 there is an input-selection 7 with the help of which the option to load an expert scenario 5 can be activated. If this is not desired, the input-selection at option “no” deviates to the input “current case” 8 in which reference data concerning demographics, current patient flow in terms of cost and outcome along paths of care are stored to give examples. Further, the input “current case” 8 comprises trends such as multi-period and complete scenarios to be monitored which can be selected at the selection-block 1 given in FIG. 1 of the flow chart described. Further, within the input “current case” 8, the reimbursements achieved with the current case can be determined.

The input-selection 7 is linked to the input “current case” 8 by means of link A. The above-mentioned information-block 6, assigned to the algorithm block 4 is linked via link E to a results-block 12 and via link D to an input “new options” labelled with reference numeral 9. The algorithm block labelled 4 interacts via link C with a check-block labelled 11 given in FIG. 2 of the flow chart.

Via link B the algorithm-block 4 communicates with the input “new options” labelled reference numeral 9. The input “new options” 9 offers the chance to enter costs, eventually modified with results if depending on—just to give an example—average daily usage of the new product. Further, this block displays how much the costs are reduced and what can be done with the freed-up capacities. It further displays the eligibility or selectiveness criteria for going a new path, i.e. using the new product such as a new diagnostic product or the new method such as a new diagnostic method. Optionally, the willingness to pay can be displayed, which offers the benefit to the user to decide to implement the new product or the new method or to disembark from the project in case the costs exceed those of certain thresholds in absolute terms or per patient.

Furthermore, optionally, a threshold can be determined for minimum reimbursement of a new drug or diagnostic test, at which the user would switch to the new alternative, after the manufacturer has successfully negotiated reimbursement with the respective state authorities.

Assigned to the input “new options” is a manufacturer-input labelled with reference numeral 10 in which new product specifications, trial results and the list prices of alternative new products of other manufacturers are stored. In case of need, the costs which are entered into the database by means of the input “new options” can be modified by the list prices of alternative products of alternative manufacturers to allow for a comparison.

After giving the inputs within input “new options” 9, the resulting new scenario is checked within check block 11. This can be done by in-tree presentation or by a step-by-step calculation. If the resulting new scenario is not ok, it is branched back to the input “new options” 9; if the resulting new scenario is found to be ok, it is stepped further to the results-block, labelled with reference numeral 12.

Within the results-block 12, the relevant data before or after treatment with the new product or the new method are displayed. Furthermore, a savings/cost effectiveness evaluation can be performed. Still further, it is possible to perform a multi-period expansion. Within the results-block 12 a display of included or excluded effects, dependent on the viewpoint of the user defined within the selection-block 1, 2 can be presented. Different representations of the result are obtained when analyzed from the viewpoint of a doctor, a hospital manager, a lab manager, a clinician or an insurance manager. Depending on the viewpoint, different information is required. If within the results-block labelled reference numeral 12 certain changes are required, it can be branched off to the refinement of analysis block 13 which offers the option to expand the scenario to different periods of the viewpoints to refine the analysis or even to adopt new data.

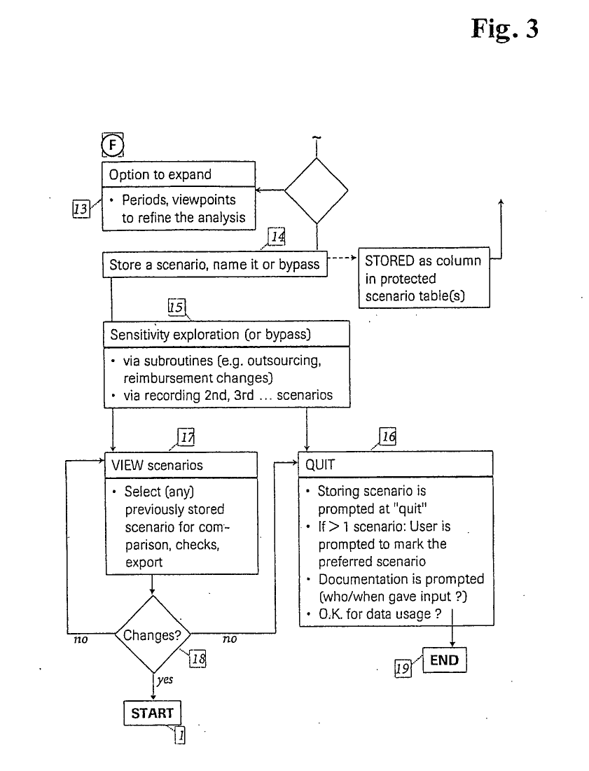

If, however, the information given in the results-block 12 is found to be appropriate, the result can be stored by means of a data and result recording 14, given on top of FIG. 3. The scenario can be stored as a dataset in the database. Such scenario tables are not accessible by unauthorized persons.

After the scenario has been stored and filed adequately a sensitivity-explanation can be performed in sensitivity block 15. Within this block it is determined for instance via subroutines whether the question of outsourcing certain activities is worthwhile or not and what kind of reimbursement changes are to be expected. Further, within the sensitivity block 15 recorded additional second or third scenarios can be compared with each other.

If the desired analysis is finalized, for example, if a sensitivity-explanation has been performed in sensitivity block 15, the quit-block 16 can be addressed. By activating the quit-block 16, the current scenario can be stored, which is prompted at the addressing of the quit-block 16. In case there have been a plurality of scenarios being generated in one session, it is asked which of those is the preferred one and a documentation is prompted including among other data the date of the scenario being established and the people that have contributed. Finally, an OK is given or can be denied for using this respective scenario for negotiating reimbursement, or for lobbying for new treatment guidelines. Then it is branched off to the end-comment 19.

As an alternative to addressing the quit-block 16 from the sensitivity block 15, the scenario can be branched off to a block 17 “view of scenarios”. Within this block any previously stored scenario can be selected for comparison reasons or in order to check the results in terms of plausibility or in terms of comparison to an expert-based scenario. If changes are required in the scenarios being determined, it is again branched off to the starting point at reference numeral 1. If, however, no changes are deemed necessary, it is branched either back to the view-block 17 of the scenarios being determined or to the quit-block 16.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

### LIST OF REFERENCE SIGNS

1 START
2 Selection-block
3 Scenario-input
4 Algorithm-block
5 Expert-scenario-option
6 Information- and remark-block
7 Input-Selection
8 Input “current case”
9 Input “new options”
10 Manufacturer-input
11 Check-block
12 Results-block
13 Refinement of analysis
14 Data and result recordal
15 Sensitivity-explanation
16 Quit-block
17 View of scenarios
18 Changes required ?
19 END

1. A computer-readable medium comprising a database, said database comprising:
a) current modes of treatment for a defined set of patients;
b) analytical parameters associated with a suggested treatment change;
c) parameters associated with treatment quality, treatment costs and reimbursement income of different providers of healthcare products and services.

2. A computer-readable medium according to claim 1, further comprising a program to perform algorithms that calculate customized sets of new parameters associated with a treatment change in an output file.

3. A method for calculating individually chosen sets of parameters associated with a treatment change, comprising
a) inputting data for description of current medical care which are relevant to a change of treatment;
b) inputting data as required for description of said change of treatment;
c) storing inputs in a database;
d) calculating a set of different parameters for administering at least two different modes of treatment;
e) presenting at least one parameter associated with treatment quality, one parameter associated with treatment costs and one parameter associated with reimbursement income.

4. A method according to claim 3, further comprising storing outputs in said database.

5. A computer program product capable of performing a method according to claim 3, by means of processing a database, characterized in that said database comprises:
a) current modes of treatment of patients;
b) parameters that describe a suggested treatment change;
c) parameters in dictating how treatment changes affect different providers of healthcare products and services differently.
